(19) United States
(12) Patent Application Publication
(10) Pub. No.: US 2020/0099797 A1
(43) Pub. Date: Mar. 26, 2020

(54) IMAGE READING APPARATUS, IMAGE FORMING APPARATUS, NON-TRANSITORY COMPUTER READABLE MEDIUM, AND IMAGE PROCESSING SYSTEM

(71) Applicant: FUJI XEROX CO., LTD., Tokyo (JP)

(72) Inventor: Akihiro ISHII, Kanagawa (JP)

(73) Assignee: FUJI XEROX CO., LTD., Tokyo (JP)

(21) Appl. No.: 16/564,713

(22) Filed: Sep. 9, 2019

(30) Foreign Application Priority Data
Sep. 21, 2018 (JP) 2018-177870

(51) Int. Cl. H04N 1/00; H04N 1/32; G06F 3/12

(52) U.S. Cl. CPC H04N 1/00225; G06F 3/1232; G06F 3/1206; H04N 1/32122

(57) ABSTRACT

An image reading apparatus includes a memory, a first transmission unit, a reception unit, and a second transmission unit. The memory stores a read image read by an image reading part. The first transmission unit transmits identification information identifying the image reading apparatus to a mobile terminal. The reception unit receives a transfer request for transferring the read image. The transfer request is received from an image forming apparatus receiving the identification information from the mobile terminal. The second transmission unit transmits the read image stored in the memory to the image forming apparatus. The read image is transmitted after the transfer request is received.

### CROSS-REFERENCE TO RELATED APPLICATIONS

This application is based on and claims priority under 35 USC 119 from Japanese Patent Application No. 2018-177870 filed Sep. 21, 2018.

### BACKGROUND

### (i) Technical Field

The present disclosure relates to an image reading apparatus, an image forming apparatus, a non-transitory computer readable medium, and an image processing system.

### (ii) Related Art

With a network system, a user of a mobile terminal may take image data read by an image forming apparatus into the mobile terminal, for example, through wireless communication in response to an instruction displayed in the received Web page, and the user may cause the image forming apparatus to print electronic data stored in the mobile terminal, for example, through wireless communication. Such a network system is known (for example, see Japanese Unexamined Patent Application Publication No. 2013-229895).

### SUMMARY

Aspects of non-limiting embodiments of the present disclosure relate to an image reading apparatus, an image forming apparatus, a non-transitory computer readable medium, and an image processing system.

If a configuration in which a read image read by an image reading apparatus is taken into a mobile terminal and the image forming apparatus forms an image based on the read image stored in the mobile terminal is employed, the mobile terminal, the image reading apparatus, and the image forming apparatus need to transmit and receive the read image to and from each other, and thus a communication method used by these apparatuses is restricted.

It is an object of the present disclosure to cause an image forming apparatus to form an image on a basis of an image read by an image reading apparatus, without restricting a communication method used by a mobile terminal, the image reading apparatus, and the image forming apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image reading apparatus including a memory, a first transmission unit, a reception unit, and a second transmission unit. The memory stores a read image read by an image reading part. The first transmission unit transmits identification information identifying the image reading apparatus to a mobile terminal. The reception unit receives a transfer request for transferring the read image. The transfer request is received from an image forming apparatus receiving the identification information from the mobile terminal. The second transmission unit transmits the read image stored in the memory to the image forming apparatus. The read image is transmitted after the transfer request is received.

### BRIEF DESCRIPTION OF THE DRAWINGS

An exemplary embodiment of the present disclosure will be described in detail based on the following figures, wherein:

FIG. 1 is a diagram illustrating an example overall configuration of an image processing system in the exemplary embodiment of the present disclosure;

FIG. 2 is a diagram illustrating an example hardware configuration of an image reading apparatus in the exemplary embodiment of the present disclosure;

FIG. 3 is a diagram illustrating an example hardware configuration of an image forming apparatus in the exemplary embodiment of the present disclosure;

FIG. 4 is a diagram illustrating an example hardware configuration of a mobile terminal in the exemplary embodiment of the present disclosure;

FIG. 5 is a block diagram illustrating an example functional configuration of the apparatuses in the image processing system in the exemplary embodiment of the present disclosure;

FIGS. 6A and 6B are sequence diagrams illustrating example operation performed in scanning in the image processing system in the exemplary embodiment of the present disclosure;

FIGS. 7A and 7B are sequence diagrams illustrating example operation performed in printing in the image processing system in the exemplary embodiment of the present disclosure;

FIGS. 8A and 8B are sequence diagrams illustrating an example operation performed in changing deletion time in the image processing system in the exemplary embodiment of the present disclosure; and

FIGS. 9A and 9B are diagrams each illustrating an example screen displayed on the mobile terminal in the exemplary embodiment of the present disclosure.

### DETAILED DESCRIPTION

Hereinafter, an exemplary embodiment of the present disclosure will be described in detail with reference to the attached drawings.

### Overall Configuration of Image Processing System

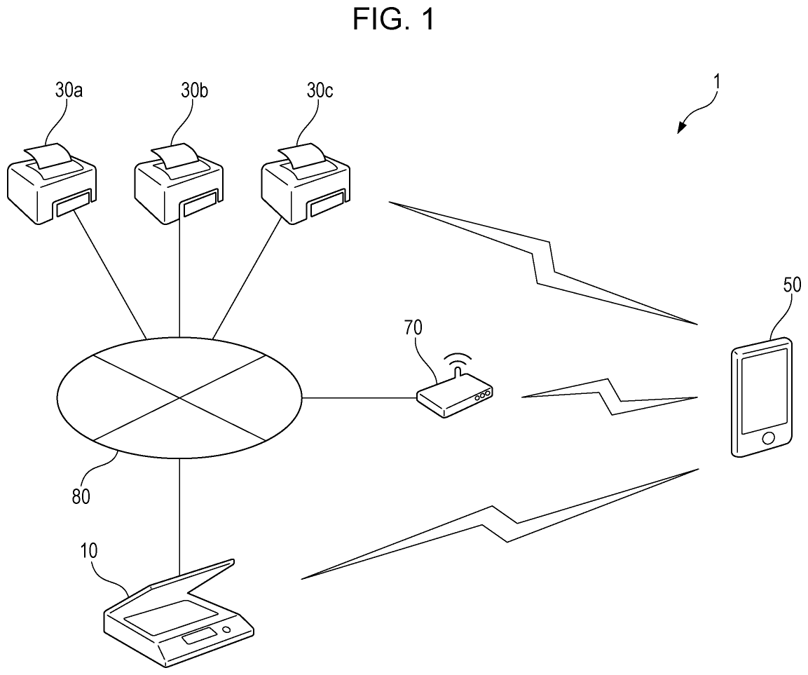

FIG. 1 is a diagram illustrating an example overall configuration of an image processing system 1 in this exemplary embodiment. As illustrated in FIG. 1, the image processing system 1 includes an image reading apparatus 10, image forming apparatuses 30a to 30c, and a mobile terminal 50. The image reading apparatus 10 and the image forming apparatuses 30a to 30c are connected to a communication network 80. In this case, the image forming apparatuses 30a to 30c may be connected to the communication network 80, for example, via a universal serial bus (USB) hub. Note that the image reading apparatus 10, the image forming apparatuses 30a to 30c, and the mobile terminal 50 support near field communication (NFC). Accordingly, the mobile terminal 50 is wirelessly connectable to the image reading apparatus 10 and the image forming apparatuses 30a to 30c through NFC. Further, the image reading apparatus 10, the image forming apparatuses 30a to 30c, and the mobile terminal 50 desirably support Bluetooth (registered trademark) or a wireless local area network (LAN). In this case, the mobile terminal 50 is wirelessly connectable to the image reading apparatus 10 and the image forming apparatuses 30a to 30c through Bluetooth (registered trademark) or the wireless LAN. Although one image reading apparatus 10 and one mobile terminal 50 are illustrated in FIG. 1, two or more image reading apparatuses 10 and two or more mobile terminals 50 may be provided. In addition, the image forming apparatuses 30a to 30c are illustrated in FIG. 1 but are each also referred to as an image forming apparatus 30 if discrimination thereamong is not needed. Although FIG. 1 illustrates only the three image forming apparatuses 30, four or more image forming apparatuses 30 may be provided.

The image reading apparatus 10 is an apparatus that reads an image from a recording medium such as a paper sheet. The description herein assumes that the image reading apparatus 10 does not form an image on a recording medium such as a paper sheet but may transmit an image to a public network. For example, the image reading apparatus 10 is a scanner from the viewpoint of only reading an image and is a facsimile machine at the transmitting end from the viewpoint of reading and transmitting an image. However, the attention is focused on only the point of reading an image from a recording medium such as a paper sheet, and thus the image reading apparatus 10 is regarded as a scanner.

The image forming apparatus 30 is an apparatus that forms an image on a recording medium such as a paper sheet. The description herein assumes that the image forming apparatus 30 does not read an image from a recording medium such as a paper sheet but may receive an image via a public network. For example, the image forming apparatus 30 is a printer from the viewpoint of only forming an image and is a facsimile machine at the receiving end from the viewpoint of receiving and forming an image.

The mobile terminal 50 is a computer used by a user who performs a copying operation with the image reading apparatus 10 and the image forming apparatus 30. Note that the mobile terminal 50 may be implemented, for example, by a smartphone.

### Hardware Configuration of Image Reading Apparatus

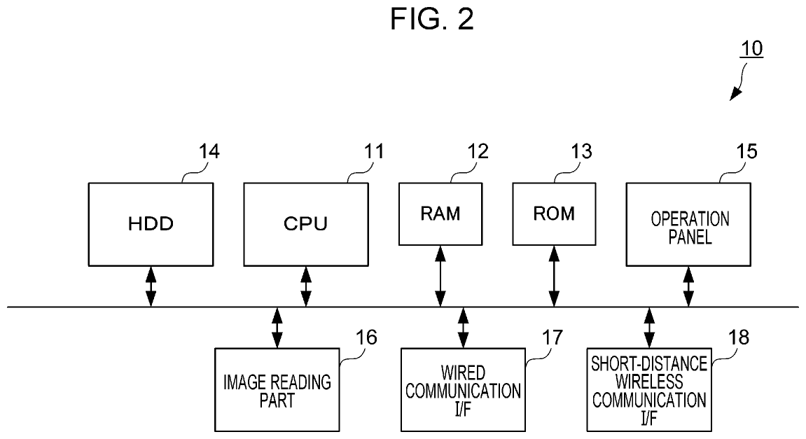

FIG. 2 is a diagram illustrating an example hardware configuration of the image reading apparatus 10 in this exemplary embodiment. As illustrated in FIG. 2, the image reading apparatus 10 includes a central processing unit (CPU) 11, a random access memory (RAM) 12, a read only memory (ROM) 13, a hard disk drive (HDD) 14, an operation panel 15, an image reading part 16, a wired communication interface (hereinafter, referred to as a wired communication I/F) 17, and a short-distance wireless communication interface (hereinafter, referred to as a short-distance wireless communication I/F) 18.

The CPU 11 implements each of functions (described later) by loading a corresponding one of various programs stored in the ROM 13 and the like into the RAM 12 and by running the program.

The RAM 12 is a memory used as a work memory for the CPU 11. The ROM 13 is a memory that stores the various programs run by the CPU 11. The HDD 14 is an example of a memory and is, for example, a magnetic disk device that stores image data and the like read by the image reading part 16.

The operation panel 15 is, for example, a touch panel that displays various pieces of information and receives operation input by a user. The operation panel 15 includes a display that displays the various pieces of information and a location detection sheet on which a location designated with a designation tool such as a finger or a stylus is detected. Alternatively, a display and a keyboard may be used instead of the touch panel.

The image reading part 16 reads an image recorded on a recording medium such as a paper sheet. As the image reading part 16, an image reading component based on a charge coupled device (CCD) system or a contact image sensor (CIS) system may be used. In the CCD system, light beams are radiated onto a document from a light source, the reflected light beams are reduced with a lens, and then the light beams are received by CCDs. In the CIS system, light beams are radiated in order onto a document from a light emitting diode (LED) light source, and the reflected light beams are received by a CIS.

The wired communication I/F 17 transmits and receives various pieces of information to and from the image forming apparatus 30 via the communication network 80 and transmits and receives various pieces of information to and from the mobile terminal 50 via the communication network 80 and an access point 70. The short-distance wireless communication I/F 18 transmits and receives various pieces of information to and from the mobile terminal 50 through short-distance wireless communication such as NFC or Bluetooth (registered trademark).

### Hardware Configuration of Image Forming Apparatus

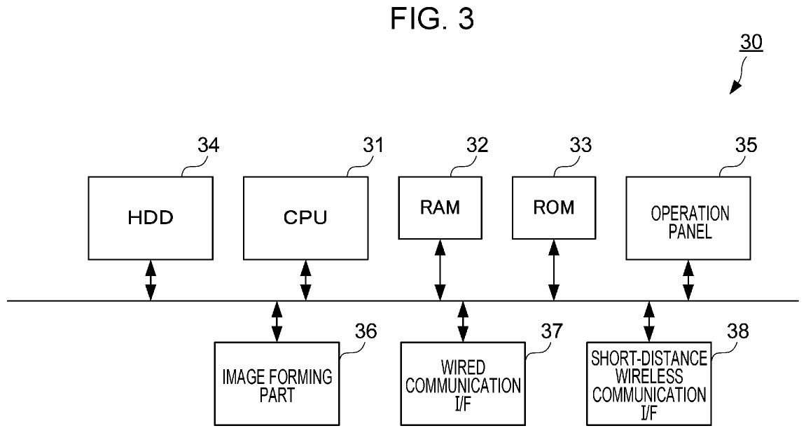

FIG. 3 is a diagram illustrating an example hardware configuration of the image forming apparatus 30 in this exemplary embodiment. As illustrated in FIG. 3, the image forming apparatus 30 includes a CPU 31, a RAM 32, a ROM 33, a HDD 34, an operation panel 35, an image forming part 36, a wired communication I/F 37, and a short-distance wireless communication I/F 38.

The CPU 31 implements each of functions (described later) by loading a corresponding one of various programs stored in the ROM 33 and the like into the RAM 32 and by running the program.

The RAM 32 is a memory used as a work memory for the CPU 31. The ROM 33 is a memory that stores the various programs run by the CPU 31. The HDD 34 is, for example, a magnetic disk device that stores image data and the like used for image forming by the image forming part 36.

The operation panel 35 is, for example, a touch panel that displays various pieces of information and receives operation input by the user. The operation panel 35 includes a display that displays the various pieces of information and a location detection sheet on which a location designated with a designation tool such as a finger or a stylus is detected. Alternatively, a display and a keyboard may be used instead of the touch panel.

The image forming part 36 forms an image on a recording medium such as a paper sheet. The image forming part 36 is an example of an image forming unit. As the image forming part 36, an image forming component based on an electrophotographic system or an inkjet system may be used. In the electrophotographic system, toner adhered to a photoconductor is transferred onto a recording medium, and thereby an image is formed. In the inkjet system, ink is jetted out onto a recording medium, and thereby an image is formed.

The wired communication I/F 37 transmits and receives various pieces of information to and from the image reading apparatus 10 via the communication network 80 and transmits and receives various pieces of information to and from the mobile terminal 50 via the communication network 80 and the access point 70. The short-distance wireless communication I/F 38 transmits and receives various pieces of information to and from the mobile terminal 50 through the short-distance wireless communication such as NFC and Bluetooth (registered trademark).

### Hardware Configuration of Mobile Terminal

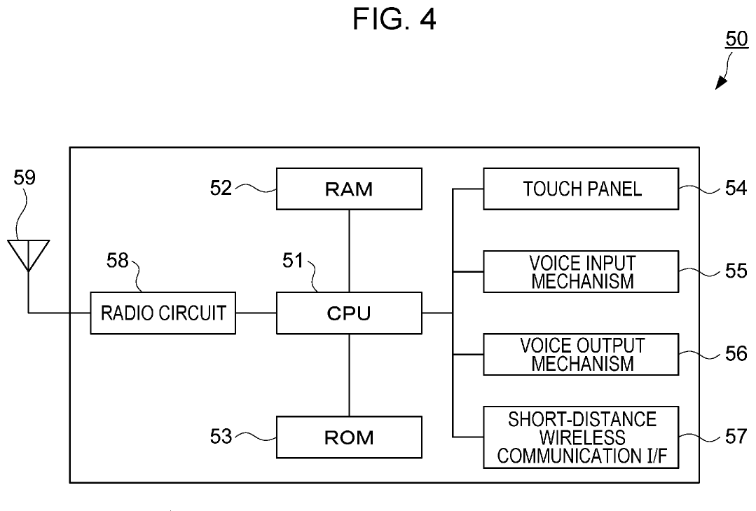

FIG. 4 is a diagram illustrating an example hardware configuration of the mobile terminal 50 in this exemplary embodiment. As illustrated in FIG. 4, the mobile terminal 50 includes a CPU 51 that is an arithmetic unit, a RAM 52 and a ROM 53 that are each a memory, a touch panel 54 that displays various pieces of information and that receives operation input by the user, a voice input mechanism 55 such as a microphone, a voice output mechanism 56 such as a speaker, and a short-distance wireless communication I/F 57 that transmits and receives various pieces of information to and from the image reading apparatus 10 or the image forming apparatus 30 through the short-distance wireless communication such as NFC or Bluetooth (registered trademark). The mobile terminal 50 also includes a radio circuit 58 and an antenna 59 for performing the wireless communication via a base station. The radio circuit 58 includes a baseband large scale integrated circuit (LSI) (not illustrated) that performs signal processing of wirelessly transmitted and received digital data.

### Exemplary Embodiment Overview

In this exemplary embodiment, in the image processing system 1 as described above, the image reading apparatus 10 stores scanned image data (hereinafter, referred to as scan data) in the HDD 14 and transmits identification information identifying the image reading apparatus 10 (hereinafter, referred to as scanner information) to the mobile terminal 50. The image forming apparatus 30 receives the scanner information from the mobile terminal 50 and transmits a request for transferring the scan data. The image reading apparatus 10 transmits the scan data stored in the HDD 14 to the image forming apparatus 30.

### Functional Configuration of Image Processing System

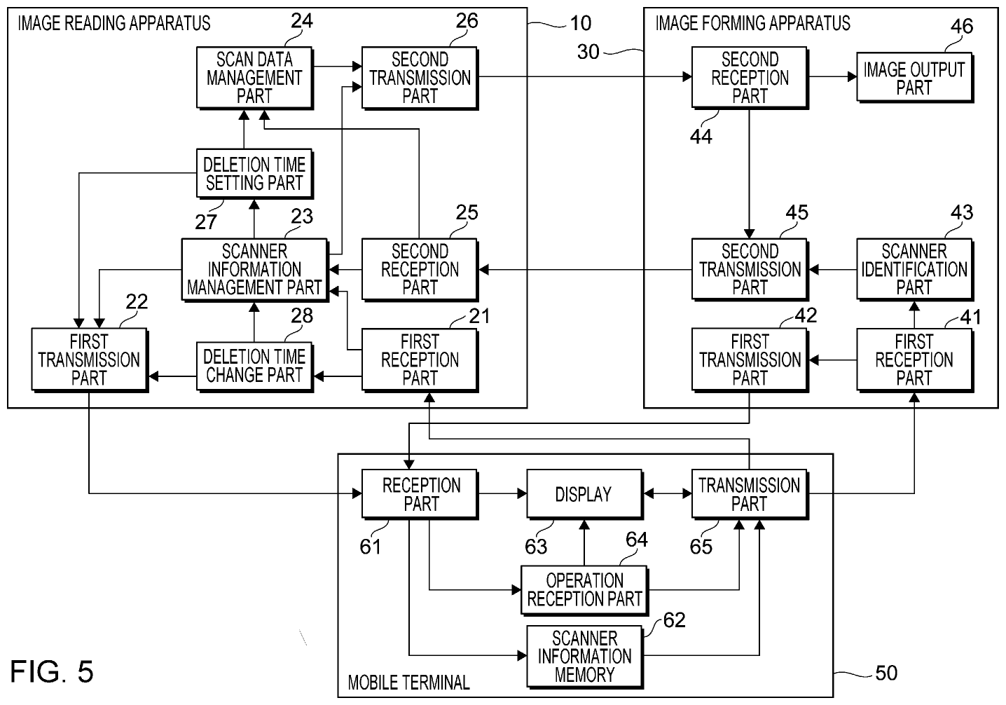

FIG. 5 is a block diagram illustrating an example functional configuration of the apparatuses in the image processing system 1 in this exemplary embodiment.

First, an example functional configuration of the image reading apparatus 10 in this exemplary embodiment will be described. The image reading apparatus 10 in this exemplary embodiment includes a first reception part 21, a first transmission part 22, a scanner information management part 23, a scan data management part 24, a second reception part 25, a second transmission part 26, a deletion time setting part 27, and a deletion time change part 28.

The first reception part 21 receives various pieces of information from the mobile terminal 50 via the wired communication I/F 17 or the short-distance wireless communication I/F 18. In particular, the first reception part 21 receives a pairing request including the scanner information from the mobile terminal 50. The first reception part 21 also receives, from the mobile terminal 50, a request for changing time to delete scan data (hereinafter, referred to as deletion time) set by the deletion time setting part 27 (described later).

The first transmission part 22 transmits various pieces of information to the mobile terminal 50 via the wired communication I/F 17 or the short-distance wireless communication I/F 18. In particular, after the scanner information management part 23 generates scanner information (described later), the first transmission part 22 transmits the scanner information to the mobile terminal 50. In addition, after the deletion time setting part 27 sets deletion time (described later), the first transmission part 22 transmits the deletion time to the mobile terminal 50. Further, after the scanner information management part 23 determines whether pairing with the mobile terminal 50 is executable (described later), the first transmission part 22 transmits the pairing execution result to the mobile terminal 50. Still further, after the deletion time change part 28 determines whether the deletion time is changeable (described later), the first transmission part 22 transmits the deletion time change result to the mobile terminal 50. In this exemplary embodiment, the first transmission part 22 is provided as an example of a first transmission unit that transmits identification information to a mobile terminal and that transmits, to the mobile terminal, information indicating that a changing unit changes the deletion time.

The scanner information management part 23 manages the scanner information that is information identifying the image reading apparatus 10. Specifically, after the image reading part 16 reads an image, the scanner information management part 23 generates the scanner information. At this time, time when the scanner information is generated is stored. After the first reception part 21 receives the pairing request from the mobile terminal 50, the scanner information management part 23 determines whether the pairing with the mobile terminal 50 is executable. If the pairing is executable, the scanner information management part 23 executes the pairing. Further, after the second reception part 25 receives the pairing request from the image forming apparatus 30, the scanner information management part 23 determines whether pairing with the image forming apparatus 30 is executable. If the pairing is executable, the scanner information management part 23 executes the pairing. The scanner information is used for the image forming apparatus 30 and the mobile terminal 50 to identify the image reading apparatus 10. In this exemplary embodiment, the scanner information management part 23 is provided as an example of a generation unit that generates identification information.

The scan data management part 24 manages the scan data read by the image reading part 16. Specifically, after the image reading part 16 reads the image, the scan data management part 24 stores the scan data in the HDD 14. After the second reception part 25 receives, from the image forming apparatus 30, a request for transmitting the scan data stored in the HDD 14, the scan data management part 24 determines whether the scan data is transmittable. If the scan data management part 24 determines that the scan data is transmittable, the scan data management part 24 reads out the scan data from the HDD 14. Further, if the scan data stored in the HDD 14 remains at the deletion time therefor, the scan data management part 24 deletes the scan data. In this exemplary embodiment, the scan data is used as an example of a read image. The scan data management part 24 is provided as an example of a deletion unit that deletes the read image.

The second reception part 25 receives various pieces of information from the image forming apparatus 30 via the wired communication I/F 17. In particular, the second reception part 25 receives the pairing request including the scanner information from the image forming apparatus 30. The second reception part 25 also receives, from the image forming apparatus 30, the request for transmitting the scan data stored in the HDD 14. In this exemplary embodiment, the second reception part 25 is provided as an example of a reception unit that receives a transfer request for transferring the read image.

The second transmission part 26 transmits various pieces of information to the image forming apparatus 30 via the wired communication I/F 17. In particular, after the scanner information management part 23 determines whether the pairing with the image forming apparatus 30 is executable, the second transmission part 26 transmits the pairing execution result to the image forming apparatus 30. Whether the pairing is executable may be determined, for example, depending on whether the scanner information included in the pairing request is scanner information identifying the image reading apparatus 10. In addition, if the scan data management part 24 determines that the scan data is transmittable, the second transmission part 26 transmits the read out scan data to the image forming apparatus 30. In this exemplary embodiment, the second transmission part 26 is provided as an example of a second transmission unit that transmits the read image to an image forming apparatus.

In addition, the second transmission part 26 may decide whether to transmit the scan data read out by the scan data management part 24 to the image forming apparatus 30, depending on whether the scanner information management part 23 determines that the pairing with the image forming apparatus 30 is executable. This is an example of deciding, by the second transmission unit, whether to transmit the read image to the image forming apparatus depending on whether the reception unit receives the identification information identifying an image reading apparatus from the image forming apparatus. Specifically, the second transmission part 26 may be configured as follows. If the scanner information management part 23 determines that the pairing with the image forming apparatus 30 is executable, the second transmission part 26 transmits, to the image forming apparatus 30, the scan data read out by the scan data management part 24. If the scanner information management part 23 does not determine that the pairing with the image forming apparatus 30 is executable, the second transmission part 26 does not transmit, to the image forming apparatus 30, the scan data read out by the scan data management part 24. The former is an example of deciding, by the second transmission unit, to transmit the read image to the image forming apparatus if the reception unit receives the identification information identifying the image reading apparatus from the image forming apparatus. The latter is an example of deciding, by the second transmission unit, not to transmit the read image to the image forming apparatus if the reception unit does not receive the identification information identifying the image reading apparatus from the image forming apparatus.

The deletion time setting part 27 sets the deletion time that is time for the scan data management part 24 to delete the scan data stored in the HDD 14. The initial value of the deletion time may be calculated by adding a predetermined period of time to time when the scanner information is generated, the time being stored in the scanner information management part 23. In this exemplary embodiment, the deletion time setting part 27 is provided as an example of a setting unit that sets the deletion time.

After the first reception part 21 receives the request for changing the deletion time from the mobile terminal 50, the deletion time change part 28 determines whether the deletion time set by the deletion time setting part 27 is changeable. If the deletion time is changeable, the deletion time change part 28 changes the deletion time. In this exemplary embodiment, the deletion time change part 28 is provided as an example of the changing unit that changes the deletion time.

An example functional configuration of the image forming apparatus 30 in this exemplary embodiment will be described. The image forming apparatus 30 in this exemplary embodiment includes a first reception part 41, a first transmission part 42, a scanner identification part 43, a second reception part 44, a second transmission part 45, and an image output part 46.

The first reception part 41 receives various pieces of information from the mobile terminal 50 via the wired communication I/F 37 or the short-distance wireless communication I/F 38. In particular, the first reception part 41 receives the scanner information stored in a scanner information memory 62 from the mobile terminal 50 (described later). In this exemplary embodiment, the first reception part 41 is provided as an example of a first reception unit that receives the identification information from the mobile terminal.

The first transmission part 42 transmits various pieces of information to the mobile terminal 50 via the wired communication I/F 37 or the short-distance wireless communication I/F 38. In particular, the first transmission part 42 transmits, to the mobile terminal 50, a result of determining whether the pairing is executed successfully.

If the first reception part 41 receives the scanner information from the mobile terminal 50, the scanner identification part 43 identifies the image reading apparatus 10 to serve as a destination of the scan data transmission request on the basis of the scanner information.

The second reception part 44 receives various pieces of information from the image reading apparatus 10 via the wired communication I/F 37. In particular, the second reception part 44 receives the pairing execution result from the image reading apparatus 10 identified by the scanner identification part 43. The second reception part 44 also receives the scan data from the paired image reading apparatus 10. In this exemplary embodiment, the second reception part 44 is provided as an example of the second reception unit that receives the read image from the image reading apparatus.

In addition, the second reception part 44 may receive the scan data from the image reading apparatus 10 depending on whether the scan data is decided to be transmitted to the image forming apparatus 30. The scan data is decided in the image reading apparatus 10 depending on whether the scanner information management part 23 determines that the pairing with the image forming apparatus 30 is executable. This is an example of receiving, by the second reception unit, the read image from the image reading apparatus depending on whether the read image is decided to be transmitted. The read image is decided in the image reading apparatus depending on whether the transmission unit transmits the identification information identifying the image reading apparatus to the image reading apparatus. Specifically, the second reception part 44 may be configured as follows. If the scan data is decided to be transmitted to the image forming apparatus 30 in the image reading apparatus 10 if the scanner information management part 23 determines that the pairing with the image forming apparatus 30 is executable, the second reception part 44 receives the scan data from the image reading apparatus 10. If the scan data is decided not to be transmitted to the image forming apparatus 30 in the image reading apparatus 10 if the scanner information management part 23 does not determine that the pairing with the image forming apparatus 30 is executable, the second reception part 44 does not receive the scan data from the image reading apparatus 10. The former is an example of receiving, by the second reception unit, the read image from the image reading apparatus if the read image is decided to be transmitted in the image reading apparatus if the transmission unit transmits the identification information identifying the image reading apparatus to the image reading apparatus. The latter is an example of not receiving, by the second reception unit, the read image from the image reading apparatus if the read image is decided not to be transmitted in the image reading apparatus if the transmission unit does not transmit the identification information identifying the image reading apparatus to the image reading apparatus.

The second transmission part 45 transmits various pieces of information to the image forming apparatus 30 via the wired communication I/F 37. In particular, the second transmission part 45 transmits the pairing request including the scanner information to the image reading apparatus 10 identified by the scanner identification part 43. The second transmission part 45 also transmits the scan data transmission request to the paired image reading apparatus 10. In this exemplary embodiment, the second transmission part 45 is provided as an example of the transmission unit that transmits the transfer request for transferring the read image to the image reading apparatus.

The image output part 46 outputs the scan data received by the second reception part 44 to the image forming part 36.

An example functional configuration of the mobile terminal 50 in this exemplary embodiment will be described. The mobile terminal 50 in this exemplary embodiment includes a reception part 61, the scanner information memory 62, a display 63, an operation reception part 64, and a transmission part 65.

The reception part 61 receives various pieces of information from the image reading apparatus 10 or the image forming apparatus 30 via the short-distance wireless communication I/F 57 or the radio circuit 58. In particular, the reception part 61 receives the scanner information from the image reading apparatus 10. The reception part 61 also receives the pairing execution result from the image reading apparatus 10. Further, the reception part 61 receives the deletion time change result from the paired image reading apparatus 10. In this exemplary embodiment, the function of the reception part 61 is used as an example of each of first receiving and second receiving. In the first receiving, identification information is received from an image reading apparatus. In the second receiving, information indicating that the read image is to be deleted at the changed deletion time is received from the image reading apparatus.

The scanner information memory 62 stores the scanner information received by the reception part 61. The scanner information may be deleted after being transmitted to the image forming apparatus 30 by the transmission part 65.

The display 63 displays, on the touch panel 54, information indicating that the reception part 61 receives the scanner information. At this time, the display 63 may display, on the touch panel 54, set time set by the deletion time setting part 27 of the image reading apparatus 10. If the transmission part 65 transmits the scanner information to the image forming apparatus 30, and if the pairing with the image reading apparatus 10 identified by the image forming apparatus 30 on the basis of the scanner information is successfully executed, the display 63 cancels the displaying of the information that indicates that the reception part 61 receives the scanner information and that is displayed on the touch panel 54. Further, the display 63 changes the displaying of the deletion time in accordance with the deletion time change result received by the reception part 61. In this exemplary embodiment, the function of the display 63 is used as an example of each of displaying in which reception information indicating that the identification information is received from the image reading apparatus is displayed, the displaying in which the reception information is cancelled, and the displaying in which the deletion time is displayed.

The operation reception part 64 receives the request for changing the deletion time from the user that is input by touching the set time displayed on the touch panel 54.

The transmission part 65 transmits various pieces of information to the image reading apparatus 10 or the image forming apparatus 30 via the short-distance wireless communication I/F 57 or the radio circuit 58. In particular, the transmission part 65 transmits the scanner information stored in the scanner information memory 62 to the image forming apparatus 30. The transmission part 65 also transmits the pairing request including the scanner information to the image reading apparatus 10. The image reading apparatus 10 that is a pairing request transmission destination may be identified on the basis of the scanner information stored in the scanner information memory 62. Further, the transmission part 65 transmits the changed deletion time received by the operation reception part 64 to the paired image reading apparatus 10. In this exemplary embodiment, the function of the transmission part 65 is used as an example of each of first transmitting in which the identification information is transmitted to the image forming apparatus and second transmitting in which an instruction to delete the read image at changed deletion time is transmitted.

### Operation of Image Processing System

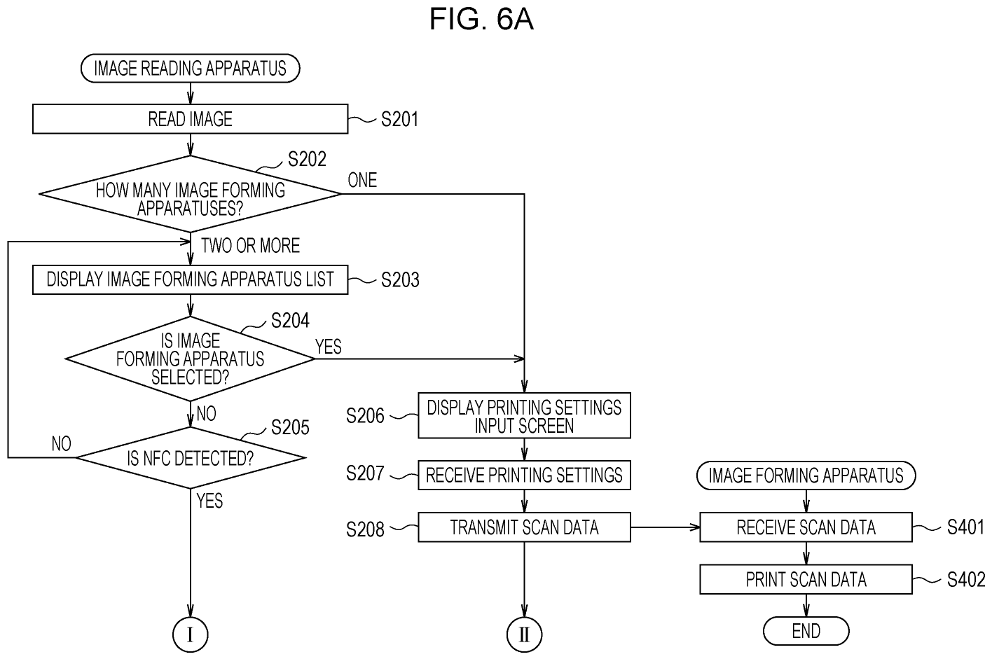

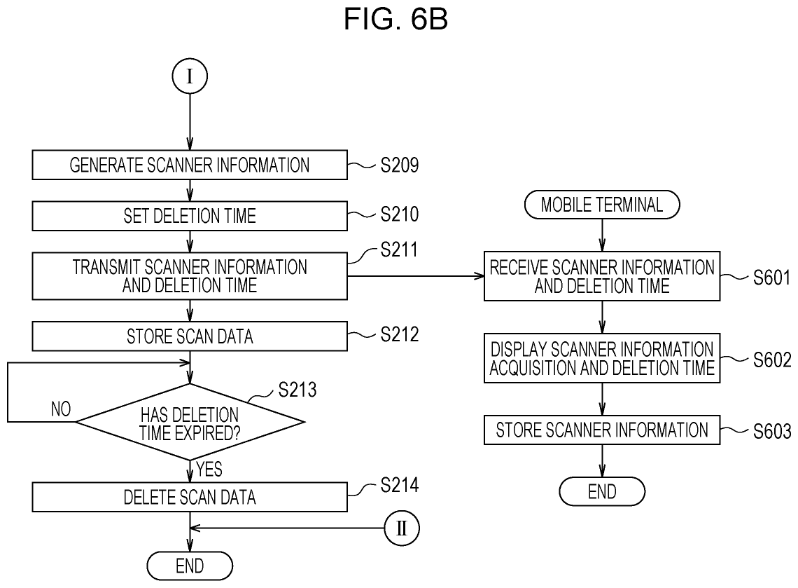

FIGS. 6A and 6B are sequence diagrams illustrating an example operation performed in scanning in the image processing system 1 in this exemplary embodiment.

First, the user places a document on the feeder or the platen and instructs the image reading apparatus 10 to start copying. In the image reading apparatus 10, the image reading part 16 reads an image from the document (step S201). The image reading apparatus 10 searches for the image forming apparatus 30 connected to the image reading apparatus 10 through the wired communication I/F 17 and determines how many image forming apparatuses 30 are connected to the image reading apparatus 10 (step S202). If the image reading apparatus 10 determines that multiple image forming apparatuses 30 are connected to the image reading apparatus 10, the image reading apparatus 10 causes the image reading part 16 to read the image, thereafter displays a list of the connected image forming apparatuses 30 on the operation panel 15 (step S203), and stops processing until an output destination image forming apparatus 30 is selected. That is, the image reading apparatus 10 determines whether the output destination image forming apparatus 30 is selected (step S204). If the image reading apparatus 10 does not determine that the output destination image forming apparatus 30 is selected, the image reading apparatus 10 determines whether the mobile terminal 50 is held over a NFC reader-writer and whether NFC is thereby detected via the short-distance wireless communication I/F 18 (step S205). If the image reading apparatus 10 does not determine that NFC is detected, the processing returns to step S203.

If the image reading apparatus 10 determines in step S202 that only one image forming apparatus 30 is connected to the image reading apparatus 10, or if the output destination image forming apparatus 30 is selected in step S204 without holding the mobile terminal 50 over the NFC reader-writer in step S205 while the processing is being stopped, the image reading apparatus 10 displays, on the operation panel 15, a screen for inputting printing settings such as the number of prints and a color mode (step S206). After the user inputs the printing settings, the image reading apparatus 10 receives the input printing settings (step S207) and transmits scan data updated with the printing settings to the image forming apparatus 30 determined as the one image forming apparatus 30 in step S202 or to the image forming apparatus 30 selected in step S204 (step S208).

The image forming apparatus 30 thereby receives the scan data from the image reading apparatus 10 (step S401). The image forming part 36 prints the scan data (step S402).

If the user holds the mobile terminal 50 supporting NFC over the NFC reader-writer of the image reading apparatus 10, the image reading apparatus 10 determines that NFC is detected via the short-distance wireless communication I/F 18. In this case, the scanner information management part 23 generates scanner information for identifying the image reading apparatus 10 (step S209). In addition, the deletion time setting part 27 sets deletion time to delete the scan data (step S210). As the deletion time, for example, time obtained by adding predetermined elapsed time to time when the scanner information is generated may be set. The first transmission part 22 transmits the scanner information generated in step S209 and the deletion time set in step S210 to the mobile terminal 50 (step S211). If handover is available, the scanner information and the deletion time may be transmitted after the communication method is changed to a high speed communication method such as Bluetooth (registered trademark) or a wireless LAN.

In the mobile terminal 50, the reception part 61 thereby receives the scanner information and the deletion time (step S601). The display 63 displays, on the touch panel 54, information indicating the acquisition of the scanner information and the deletion time (step S602). The scanner information memory 62 stores the scanner information received in step S601 (step S603).

In the image reading apparatus 10, after the scanner information and the deletion time are transmitted to the mobile terminal 50 in this manner, the scan data management part 24 accumulates the scan data read in step S201 in the HDD 14 of the image reading apparatus 10 (step S212).

The deletion time is set in the scan data accumulated in the HDD 14 as described above. If the scan data is not output until the deletion time despite the copying start instruction given by the user, the scan data is deleted. That is, the scan data management part 24 determines whether the deletion time set in step S210 has expired in the image reading apparatus 10 (step S213). If the scan data management part 24 does not determine that the deletion time has expired, step S213 is repeated. If the scan data management part 24 determines that the deletion time has expired, the scan data management part 24 deletes the scan data accumulated in the HDD 14 in step S212 (step S214).

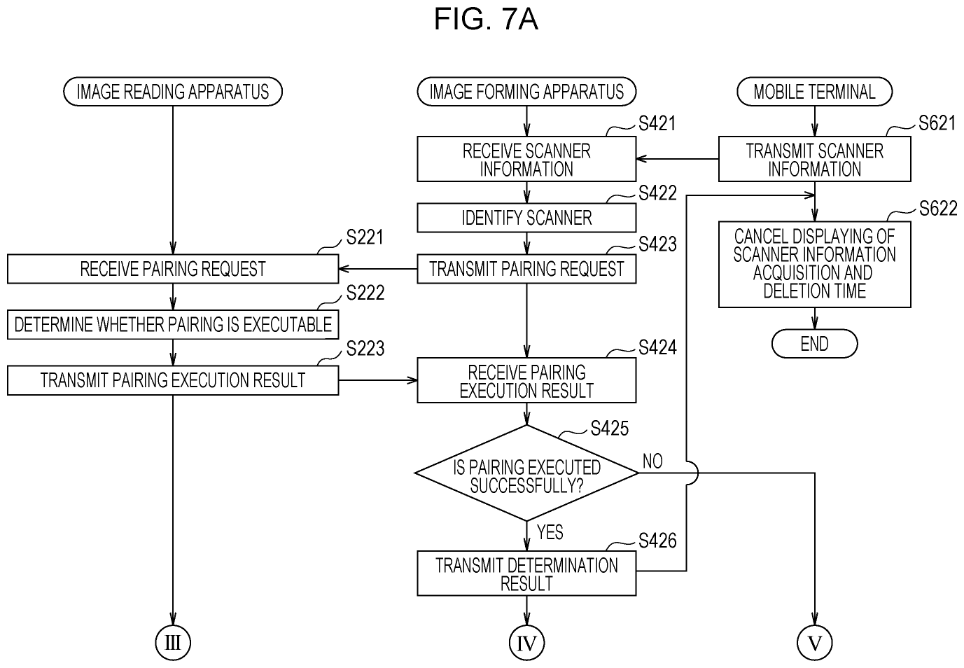

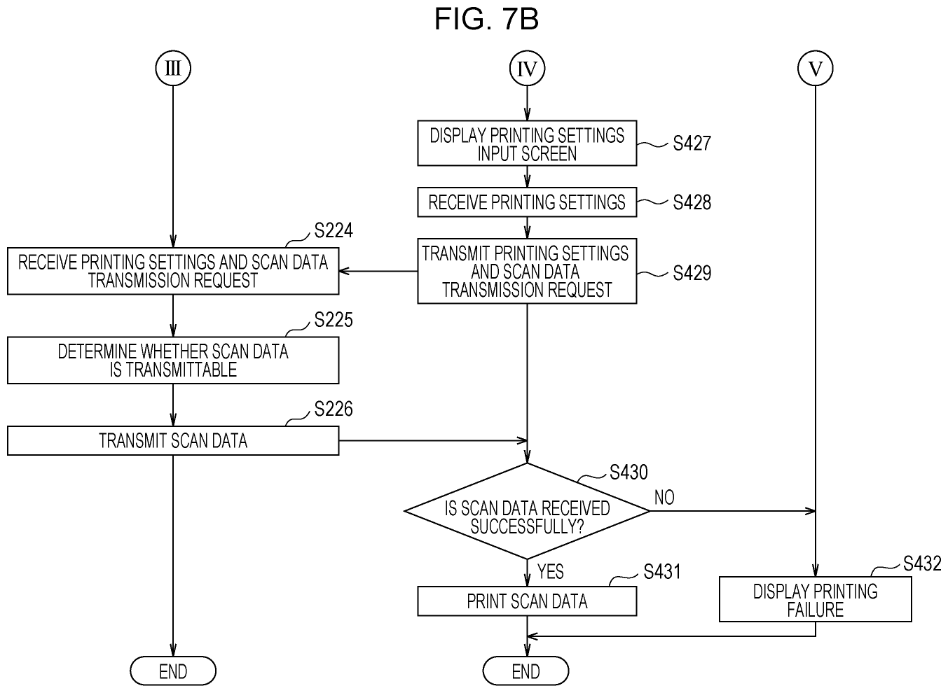

FIGS. 7A and 7B are sequence diagrams illustrating an example operation performed in printing in the image processing system 1 in this exemplary embodiment.

When the user holds the mobile terminal 50 holding the scanner information over the NFC reader-writer of the image forming apparatus 30, the transmission part 65 transmits the scanner information in the mobile terminal 50 to the image forming apparatus 30 through NFC (step S621).

In the image forming apparatus 30, the first reception part 41 receives, from the mobile terminal 50, the scanner information transmitted in step S621 (step S421). If handover is available, the scanner information may be received after the communication method is changed to a high speed communication method such as Bluetooth (registered trademark) or a wireless LAN. After the scanner information is received in step S421, the scanner identification part 43 identifies the image reading apparatus 10 that is a scan data request destination on the basis of the scanner information (step S422). The second transmission part 45 transmits a pairing request including the scanner information to the image reading apparatus 10 that is the scan data request destination (step S423).

In the image reading apparatus 10, the second reception part 25 thereby receives, from the image forming apparatus 30, the pairing request transmitted in step S423 (step S221). The scanner information management part 23 determines whether the pairing is executable (step S222). In this case, for example, the scanner information management part 23 determines whether the scanner information included in the pairing request is scanner information for identifying the image reading apparatus 10. Alternatively, the scanner information management part 23 may determine whether the image reading apparatus 10 is performing different processing and thus is not in a state where the pairing is not executable. If the pairing is executable, the scanner information management part 23 executes the pairing. Thereafter, the second transmission part 26 transmits the pairing execution result to the image forming apparatus 30 (step S223).

In the image forming apparatus 30, the second reception part 44 receives the pairing execution result transmitted in step S223 (step S424) and determines whether the pairing is executed successfully (step S425). If the second reception part 44 determines that the pairing is executed successfully, the first transmission part 42 transmits the determination result indicating that the pairing is executed successfully to the mobile terminal 50 (step S426), and the display 63 cancels the displaying that indicates the acquisition of the scanner information and the deletion time and that is performed in step S602 in FIG. 6B in the mobile terminal 50 (step S622). If the second reception part 44 determines that the pairing is executed successfully, the image forming apparatus 30 displays, on the operation panel 35, the screen for inputting the printing settings such as the number of prints and a color mode (step S427). After the user inputs the printing settings, the image forming apparatus 30 receives the input printing settings (step S428). The image forming apparatus 30 transmits the printing settings and a scan data transmission request to the image reading apparatus 10 identified in step S422 and thereby requests the image reading apparatus 10 to transmit the scan data updated with the printing settings (step S429).

In the image reading apparatus 10, the second reception part 25 thereby receives the printing settings and the scan data transmission request transmitted in step S429 (step S224). The scan data management part 24 determines whether the scan data is transmittable (step S225). In this case, for example, the scan data management part 24 determines whether the image forming apparatus 30 transmits the scan data transmission request before the deletion time and whether the scan data is accumulated in the HDD 14. Alternatively, the scan data management part 24 may determine whether the image reading apparatus 10 is not in a state where the scan data is not transmittable for some reason. If the scan data management part 24 determines that the scan data is transmittable, the second transmission part 26 transmits the scan data updated with the printing settings to the image forming apparatus 30 (step S226).

In the image forming apparatus 30, the second reception part 44 determines whether the scan data is received from the image reading apparatus 10 successfully (step S430). If the second reception part 44 determines that the scan data is received successfully, the image output part 46 outputs the scan data to the image forming part 36, and thereby the image forming part 36 prints the scan data (step S431). The series of copying steps are then terminated.

In contrast, if the second reception part 44 does not determine in step S425 that the pairing is executed successfully, or if the second reception part 44 does not determine in step S430 that the scan data is received successfully, the image forming apparatus 30 displays information indicating that the printing fails on the operation panel 35 (step S432).

Note that in this exemplary embodiment, the deletion time may be changed. For example, the user postpones the deletion time with the mobile terminal 50 through NFC, Bluetooth (registered trademark), a wireless LAN, or the like.

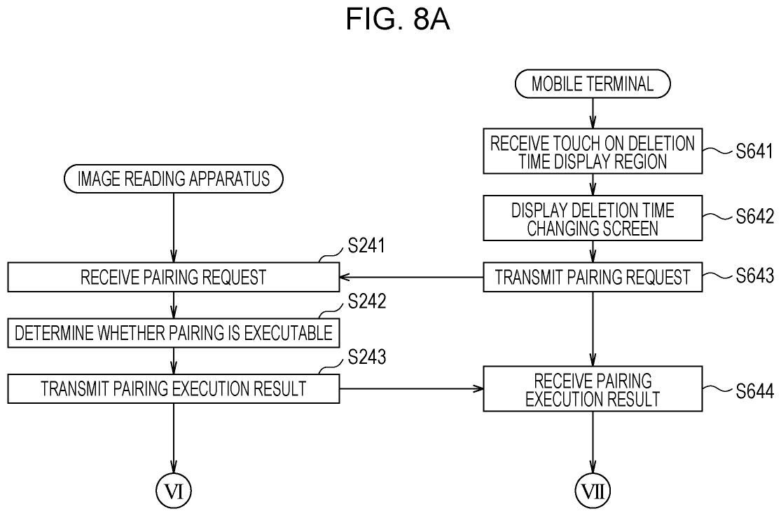

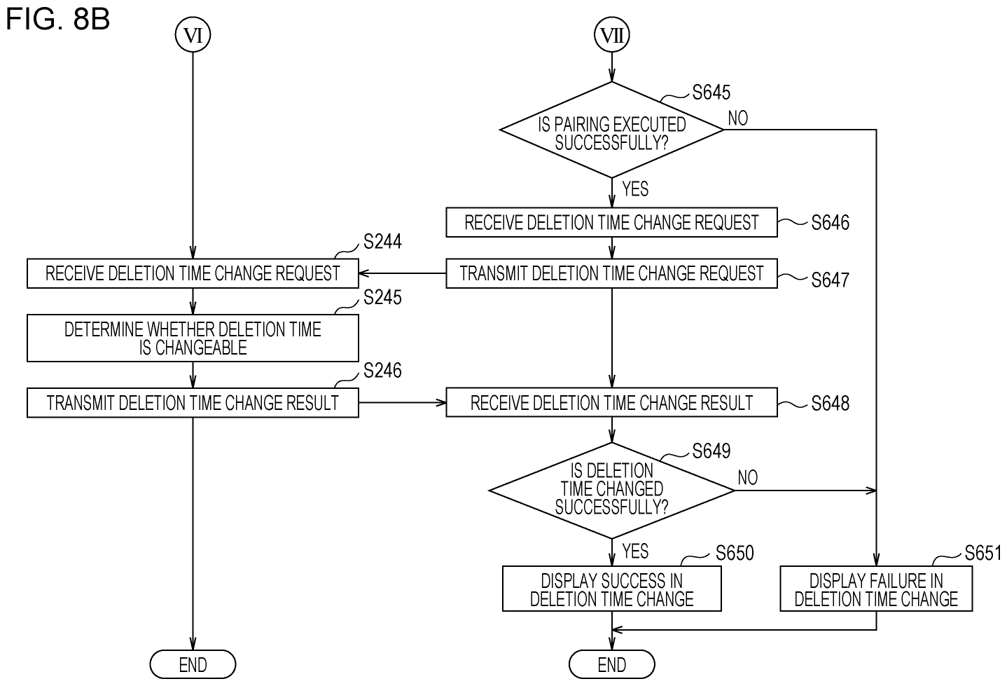

FIGS. 8A and 8B are sequence diagrams illustrating an example operation performed in changing the deletion time in the image processing system 1 in this exemplary embodiment.

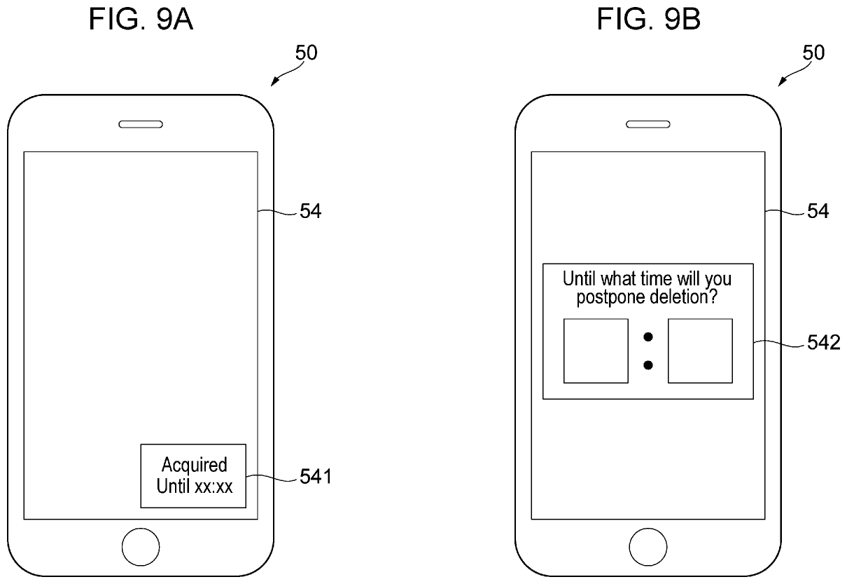

When the user touches a region where the deletion time is displayed on the touch panel 54 of the mobile terminal 50, the operation reception part 64 receives the touch operation in the mobile terminal 50 (step S641). For example, a screen illustrated in FIG. 9A is displayed on the touch panel 54 of the mobile terminal 50 in step S602 in FIG. 6B, and the operation reception part 64 thus receives the touch operation performed on a region 541. The display 63 displays a screen for changing the deletion time on the touch panel 54 (step S642). For example, a screen including a region 542 illustrated in FIG. 9B is displayed on the touch panel 54 of the mobile terminal 50. The transmission part 65 transmits a pairing request including the scanner information to the image reading apparatus 10 (step S643).

In the image reading apparatus 10, the first reception part 21 thereby receives, from the mobile terminal 50, the pairing request transmitted in step S643 (step S241). The scanner information management part 23 determines whether the pairing is executable (step S242). In this case, for example, the scanner information management part 23 determines whether the scanner information included in the pairing request is scanner information for identifying the image reading apparatus 10. Alternatively, the scanner information management part 23 may determine whether the image reading apparatus 10 is performing different processing and thus is not in a state where the pairing is not executable. If the pairing is executable, the scanner information management part 23 executes the pairing. Thereafter, the first transmission part 22 transmits the pairing execution result to the mobile terminal 50 (step S243).

In the mobile terminal 50, the reception part 61 receives the pairing execution result transmitted in step S243 (step S644) and determines whether the pairing is executed successfully (step S645). At this time, the user inputs the deletion time change request by designating changed deletion time, for example, in the region 542 of the screen illustrated in FIG. 9B and displayed in step S642. Accordingly, if the reception part 61 determines that the pairing is executed successfully, the operation reception part 64 receives the input deletion time change request in the mobile terminal 50 (step S646), and the transmission part 65 transmits a deletion time change request to the image reading apparatus 10 (step S647).

In the image reading apparatus 10, the first reception part 21 thereby receives, from the mobile terminal 50, the deletion time change request transmitted in step S647 (step S244). The deletion time change part 28 determines whether the deletion time is changeable (step S245). In this case, for example, the deletion time change part 28 determines whether the changed deletion time is a permitted time. Examples of the case where the changed deletion time is a permitted time include a case where the changed deletion time is not past time and a case where the changed deletion time is earlier than time that is a predetermined threshold time or longer past the currently set deletion time. If the deletion time is changeable, the deletion time change part 28 changes the deletion time. Thereafter, the first transmission part 22 transmits the deletion time change result to the mobile terminal 50 (step S246).

In the mobile terminal 50, the reception part 61 receives the deletion time change result transmitted in step S246 (step S648) and determines whether the deletion time is changed successfully (step S649). If the reception part 61 determines that the deletion time is changed successfully, the display 63 displays information indicating that the deletion time is changed successfully on the touch panel 54 in the mobile terminal 50 (step S650).

In contrast, if the reception part 61 does not determine in step S645 that the pairing is executed successfully, or if the reception part 61 does not determine in step S649 that the deletion time is changed successfully, the display 63 displays information indicating that the deletion time changing fails on the touch panel 54 in the mobile terminal 50 (step S651).

### Program

The processing performed by the mobile terminal 50 in this exemplary embodiment is prepared as a program such as application software.

That is, the program that implements this exemplary embodiment is regarded as a program causing a computer to execute a process including first receiving and first transmitting. In the first receiving, identification information identifying an image reading apparatus is received from the image reading apparatus. In the first transmitting, the identification information is transmitted to an image forming apparatus as information for identifying the image reading apparatus that stores a read image read by the image reading apparatus. The read image is to be transferred to the image forming apparatus to form an image.

Note that the program that implements this exemplary embodiment may be provided by using not only a communication medium but also in such a manner as to be recorded in a recording medium such as a compact disc ROM (CD-ROM).

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image reading apparatus comprising:
a memory that stores a read image read by an image reading part;
a first transmission unit that transmits identification information identifying the image reading apparatus to a mobile terminal;
a reception unit that receives a transfer request for transferring the read image, the transfer request being received from an image forming apparatus receiving the identification information from the mobile terminal; and
a second transmission unit that transmits the read image stored in the memory to the image forming apparatus, the read image being transmitted after the transfer request is received.

2. The image reading apparatus according to claim 1,
wherein the second transmission unit decides whether to transmit the read image to the image forming apparatus depending on whether the reception unit receives the identification information from the image forming apparatus.

3. The image reading apparatus according to claim 2,
wherein if the reception unit receives the identification information from the image forming apparatus, the second transmission unit decides to transmit the read image to the image forming apparatus.

4. The image reading apparatus according to claim 2,
wherein if the reception unit does not receive the identification information from the image forming apparatus, the second transmission unit decides not to transmit the read image to the image forming apparatus.

5. The image reading apparatus according to claim 1, further comprising:
a deletion unit that deletes the read image at deletion time predetermined as time to delete the read image stored in the memory.

6. The image reading apparatus according to claim 5, further comprising:
a generation unit that generates the identification information after the image reading part reads the read image; and
a setting unit that sets the deletion time on a basis of generation time when the identification information is generated and predetermined elapsed time.

7. The image reading apparatus according to claim 5, further comprising:
a changing unit that changes the deletion time in response to a request for changing the deletion time, the request being transmitted from the mobile terminal.

8. The image reading apparatus according to claim 7,
wherein if the changing unit changes the deletion time, the first transmission unit transmits, to the mobile terminal, information indicating that the changing unit changes the deletion time.

9. An image forming apparatus comprising:
a first reception unit that receives identification information identifying an image reading apparatus, the identification information being received from a mobile terminal receiving the identification information from the image reading apparatus;
a transmission unit that transmits, to the image reading apparatus, a transfer request for transferring a read image that is read by the image reading apparatus identified by the identification information and that is stored in the image reading apparatus;
a second reception unit that receives, from the image reading apparatus, the read image transmitted by the image reading apparatus in response to the transfer request; and
an image forming unit that forms an image on a basis of the read image.

10. The image forming apparatus according to claim 9,
wherein the second reception unit receives the read image from the image reading apparatus depending on whether the read image is decided to be transmitted, the read image being decided in the image reading apparatus depending on whether the transmission unit transmits the identification information to the image reading apparatus.

11. The image forming apparatus according to claim 10,
wherein if the read image is decided to be transmitted in the image reading apparatus if the transmission unit transmits the identification information to the image reading apparatus, the second reception unit receives the read image from the image reading apparatus.

12. The image forming apparatus according to claim 10,
wherein if the read image is decided not to be transmitted in the image reading apparatus if the transmission unit does not transmit the identification information to the image reading apparatus, the second reception unit does not receive the read image from the image reading apparatus.

13. A non-transitory computer readable medium storing a program causing a computer to execute a process comprising:
first receiving in which identification information identifying an image reading apparatus is received from the image reading apparatus; and
first transmitting in which the identification information is transmitted to an image forming apparatus as information for identifying the image reading apparatus that stores a read image read by the image reading apparatus, the read image being to be transferred to the image forming apparatus to form an image.

14. The non-transitory computer readable medium according to claim 13, storing the program causing the computer to execute the process further comprising:
displaying reception information indicating that the identification information is received from the image reading apparatus.

15. The non-transitory computer readable medium according to claim 14,
wherein in the displaying, after the identification information is transmitted to the image forming apparatus in the first transmitting, the reception information is cancelled.

16. The non-transitory computer readable medium according to claim 13, storing the program causing the computer to execute the process further comprising:
displaying deletion time predetermined as time to delete the read image stored in the image reading apparatus.

17. The non-transitory computer readable medium according to claim 16, storing the program causing the computer to execute the process further comprising:
second transmitting in which an instruction to delete the read image stored in the image reading apparatus at changed deletion time is transmitted in response to an operation for changing the deletion time displayed in the displaying of the deletion time.

18. The non-transitory computer readable medium according to claim 17, storing the program causing the computer to execute the process further comprising:
second receiving in which if the deletion time to delete the read image stored in the image reading apparatus is changed to the changed time, information indicating that the read image is to be deleted at the changed deletion time is received from the image reading apparatus.

19. The non-transitory computer readable medium according to claim 17,
wherein if the deletion time to delete the read image stored in the image reading apparatus is changed to the changed deletion time by transmitting the identification information to the image reading apparatus in the second transmitting, information indicating that the read image is to be deleted at the changed deletion time is received from the image reading apparatus in the second receiving.

20. An image processing system comprising:
an image reading apparatus that reads an image from a medium; and
an image forming apparatus that forms an image on a medium,
wherein the image reading apparatus stores a read image read from a medium and transmits identification information identifying the image reading apparatus to a mobile terminal,
wherein the image forming apparatus receives the identification information from the mobile terminal and transmits, to the image reading apparatus, a transfer request for transferring the read image read by and stored in the image reading apparatus identified by the identification information,
wherein the image reading apparatus receives the transfer request from the image forming apparatus and transmits the read image stored in the image reading apparatus to the image forming apparatus, the read image being transmitted after the transfer request is received, and
wherein the image forming apparatus receives the read image from the image reading apparatus and forms an image on a medium on a basis of the read image.
